(19) United States
(12) Patent Application Publication
(10) Pub. No.: US 2024/0013272 A1
(43) Pub. Date: Jan. 11, 2024

(54) Item Eligibility and/or Promotion Determination Application

(71) Applicant: E2INTERACTIVE, INC., ATLANTA, GA (US)

(72) Inventors: Andrew Orrock, Dallas, TX (US); David Vielehr, Dallas, TX (US)

(73) Assignee: E2INTERACTIVE, INC., ATLANTA, GA (US)

(21) Appl. No.: 17/859,254

(22) Filed: Jul. 7, 2022

(51) Int. Cl. G06Q 30/06; G06Q 30/02

(52) U.S. Cl. CPC G06Q 30/0623; G06Q 30/0201; G06Q 30/0211

(57) ABSTRACT

In general, the present invention is directed to systems and methods of utilizing an application operating on a mobile device to determine any applicable offers or eligibility and rank such offers and eligibility for user selection. More specifically, a process may be conducted by a processor in communication with a mobile device and data stores including user data, retailer data, and/or product and service data, the process including comparing identification information associated with a product or service received from the mobile device with data in the data stores; determining the product or service and identifying any associated promotional offers or plan eligibility associated with the product or service, the user, and/or the retailer; ranking any promotional offers or plan eligibility based at least in part on size of promotion; transmitting to the mobile device an identifier of applicable promotional offers or plan eligibility.

### FIELD OF THE INVENTION

The present invention is generally directed to systems and methods of using a

mobile device to determine item eligibility in a customer program. More specifically, and in accordance with some embodiments of the present invention, a mobile device may be used to determine eligibility, based at least in part on information captured by or read by the mobile device.

### BACKGROUND

More and more merchants offer customer loyalty programs. From clothing retailers to pharmacies, local mom-and-pop stores to big box retailers, merchants are often willing to exchange discounts for customer loyalty (and in many cases, purchasing and behavior data for mining).

In addition to customer loyalty programs, various groups, organizations, and associations frequently negotiate for their members certain discounts, special reduced rates, etc. Such discounts and promotions may be negotiated for any number of eligible services (e.g., a discount on an insurance policy), overall discounts (e.g., 2% off all purchases from a specific retailer), and/or discounts for specific goods, often provided at a manufacturer level.

Moreover, various insurance plans may offer various goods or services to insureds at a reduced rate. For example, some insurance companies have negotiated either reduced rates for various products or services, or may offer a rebate value for the purchase of such products or services. Some of the difficult aspects of determining insurance eligibility for specific products and services at a specific retailer may be based on a lack of consistency across brands and merchants, as well as changes that may be made by insurance carriers to the lists of covered or eligible products.

Added into this mix, retailers, manufacturers, and other parties frequently provide coupons, discounts, cross-promotions, etc. that may provide a reduced price for goods or services.

Given the multitude of programs—which may be dependent upon the identity of the user, the identity of the retailer, the specific retailer location, various membership programs of the customer (or even specific entitlements), and the specific goods or services—it may be difficult for a customer to know that he or she is using the most advantageous promotion or discount.

Accordingly, it is desirable to provide consumers with a device that can capture and/or determine information associated with eligibility in a number of programs, and work in (at least periodic) communication with a central processor to determine eligibility and advantageous applicable programs or promotions.

### SUMMARY OF THE INVENTION

In accordance with some embodiments of the present invention, aspects may include a system, comprising: a processor; one or more data stores, the one or more data stores storing data comprising: user data, including memberships, groups, plans, and/or entitlements associated with a user; retailer data, including: products and services offered by a retailer; any promotional offers offered by the retailer; product and service data, including identification information of each product and service, and any promotional offers or plan eligibility associated with the product or service; wherein the processor is in selective communication with one or more retailers, manufacturers, membership plans, insurance providers, and/or entitlement providers to populate and update the one or more data stores; wherein the processor is in selective communication with a mobile device of the user; wherein the processor further comprises a memory that stores executable instructions that, when executed by the processor facilitate the performance of operations comprising: comparing first media data comprising identification information associated with a product or service received from the mobile device with product and service data stored in the one or more data stores; based at least in part on the comparing, determining the product or service and identifying any promotional offers or plan eligibility associated with the product or service, the user, and/or the retailer; ranking any promotional offers or plan eligibility associated with the product or service, the user, and/or the retailer based at least in part on size of promotion; transmitting to the mobile device an identifier of one or more applicable promotional offers or plan eligibility, the identifier being presentable by the user to obtain the one or more promotional offers or plan eligibility.

In accordance with some embodiments of the present invention, aspects may include a process conducted by a processor in selective communication with a mobile device of a user and one or more data stores, the one or more data stores storing data comprising user data, retailer data, and/or product and service data, the process conducted by executable instructions that, when executed by the processor cause: comparing first media data comprising identification information associated with a product or service received from the mobile device with product and service data stored in the one or more data stores; based at least in part on the comparing, determining the product or service and identifying any promotional offers or plan eligibility associated with the product or service, the user, and/or the retailer; ranking any promotional offers or plan eligibility associated with the product or service, the user, and/or the retailer based at least in part on size of promotion; transmitting to the mobile device an identifier of one or more applicable promotional offers or plan eligibility, the identifier being presentable by the user to obtain the one or more promotional offers or plan eligibility.

In accordance with some embodiments of the present invention, aspects may include a software application residing on a mobile device, the software application executing instructions causing: soliciting data applicable to a user, retailer, and/or product or service through a user interface; receiving input of data applicable to a user plan or membership, and/or product or service, wherein the input of data comprises an image captured by a camera functionality of the mobile device; identifying the user plan or membership, and/or product or service based at least in part on the image; determining any promotional offers or plan eligibility applicable to the user plan or membership, retailer, and/or product or service; determining a location of the mobile device based at least in part on a location services functionality of the mobile device, and based at least in part on the location determining any proximate retailers; determining any promotional offers or plan eligibility offered by the proximate retailers; ranking any promotional offers or plan eligibility associated with the product and/or service, the user plan or membership, and/or the retailer based at least in part on size of promotion; displaying to the user for selection an identifier of one or more applicable promotional offers or plan eligibility; upon receiving user input selecting one or more applicable promotional offers or plan eligibility, displaying on a graphical user interface of the mobile device a computer readable indicia of the one or more applicable promotional offers or plan eligibility, if any.

These and other aspects will become apparent from the following description of the invention taken in conjunction with the following drawings, although variations and modifications may be effected without departing from the scope of the novel concepts of the invention.

### DESCRIPTION OF THE FIGURES

The present invention can be more fully understood by reading the following detailed description together with the accompanying drawings, in which like reference indicators are used to designate like elements. The accompanying figures depict certain illustrative embodiments and may aid in understanding the following detailed description. Before any embodiment of the invention is explained in detail, it is to be understood that the invention is not limited in its application to the details of construction and the arrangements of components set forth in the following description or illustrated in the drawings. The embodiments depicted are to be understood as exemplary and in no way limiting of the overall scope of the invention. Also, it is to be understood that the phraseology and terminology used herein is for the purpose of description and should not be regarded as limiting. The detailed description will make reference to the following figures, in which:

FIG. 1 illustrates an exemplary process for enrolling a user, in accordance with some embodiments of the present invention.

FIG. 2 illustrates an exemplary process for compiling and/or updating offers,

promotions, and/or eligibility, in accordance with some embodiments of the present invention.

FIG. 3 illustrates an exemplary process for identifying a retailer, in accordance

with some embodiments of the present invention.

FIG. 4 illustrates an exemplary process for identifying a product or service, in

accordance with some embodiments of the present invention.

FIG. 5 depicts a block diagram of an exemplary system, in accordance with some

embodiments of the present invention.

FIG. 6 illustrates exemplary screenshots of card features, in accordance with

some embodiments of the present invention.

FIG. 7 illustrates exemplary screenshots of an item search, in accordance with

some embodiments of the present invention.

FIG. 8 illustrates exemplary screenshots of item eligibility and discount

determination, in accordance with some embodiments of the present invention.

FIG. 9 illustrates exemplary screenshots of user reporting potential errors, in accordance with some embodiments of the present invention.

### DETAILED DESCRIPTION

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also, it is to be understood that the phraseology and terminology used herein is for the purpose of description and should not be regarded as limiting.

The matters exemplified in this description are provided to assist in a comprehensive understanding of various exemplary embodiments disclosed with reference to the accompanying figures. Accordingly, those of ordinary skill in the art will recognize that various changes and modifications of the exemplary embodiments described herein can be made without departing from the spirit and scope of the claimed invention. Descriptions of well-known functions and constructions are omitted for clarity and conciseness. Moreover, as used herein, the singular may be interpreted in the plural, and alternately, any term in the plural may be interpreted to be in the singular.

In general, the present invention provides systems and methods to monitor and patrol various memberships (with differing benefits, which may for example be based upon a user's class of membership), different promotions (that may have a temporal limitation), and different benefits (for example, from insurance companies there may be certain OTC eligibility, HSA eligibility, etc.; there may also be eligibility under Women, Infants, and Children (WIC) programs, etc.). The present invention may encompass numerous embodiments, including but not limited to insurance eligibility determinations at a retailer, ensuring best or most advantageous promotions or deals for certain products and/or services, coupon and/or promotion tracking, and/or combining promotions and eligibility automatically with limited user interaction.

Each of these aspects may be provided to a user through an application (or “app”) in selective communication with a central processor. The present invention may utilize information regarding (i) a good or service selected; (ii) one or more identified merchants; and/or (iii) programs, one or more selected memberships, and/or promotions that may be applicable to the good or service, user, or merchant. These pieces of information may be received into the system through a variety of methods, manners, and devices. For example, as discussed above a retailer may be automatically identified or may be manually selected. Identification of a retailer may be input by a user by entering the retailer's name or selected from a drop down menu. Similarly, a user may manually enter an insurance provider and/or insurance plan identification number, group number, etc. Customer loyalty programs may be determined based on loyalty number, or at times telephone number of user.

In accordance with some embodiments of the present invention, the application may use and leverage a camera functionality of a user device that may be present on many if not most user devices. The user may utilize the camera functionality to capture an image of an insurance card, loyalty card, identification card, etc. to associate programs or memberships with the user. Moreover, the camera functionality may be used by the user to capture individual promotions. For example, a coupon may be offered by a specific manufacturer for a specific product. The camera functionality may be used to capture an image of the coupon itself, or information identifying the coupon (bar code, etc.).

Similarly, a user may utilize the camera functionality to identify a good or service. Such identification may occur, for example, by capturing an image of the good or services bar code, serial number, label, tag, etc. In situations where goods or services may be provided with a radio frequency identification (RFID) tag or other wireless communication device or tag, such tag may be wireless interrogated or read by the mobile device.

As discussed in greater detail below, the user device may also be used to determine or identify associated retailers. A retailer may be assumed or may be suggested to a user based upon a picture or image of retailer signage or storefront, from determining the location of the user device through geolocation, by analyzing various present wireless networks, and/or by monitoring or interacting with various social media sights, such as but not limited to FourSquare, Facebook, Yelp, Instagram, etc.

In addition to camera functionality on a user device, it is also contemplated that in accordance with some embodiments peripheral devices may also be used. For example, a user device may be equipped with an external bar code reader that may quickly and accurately capture barcodes (such as but not limited to one-dimensional barcodes (e.g., UPCs), two-dimensional bar codes (e.g., QR code, Aztec code, etc.). Alternatively, external peripheral cameras, lenses, magnetic stripe readers, chip card readers, RFID interrogators/readers, and/or other devices may be utilized.

In accordance with some embodiments of the present invention, offers associated with membership programs or goods or services (such as redeemable value, discounts on certain goods or services, etc.) may be provided to a user in return for the user taking a survey or supplying other such information to a provider. For example, a user may receive a communication from a provider of the user's health plan that if the user completes a short survey regarding the user's health habits, the user may receive value redeemable for certain goods or services. In this situation the health plan provider may obtain more detailed information about the specific user and the provider's client base as a whole, and the user may receive direct benefit for providing such information.

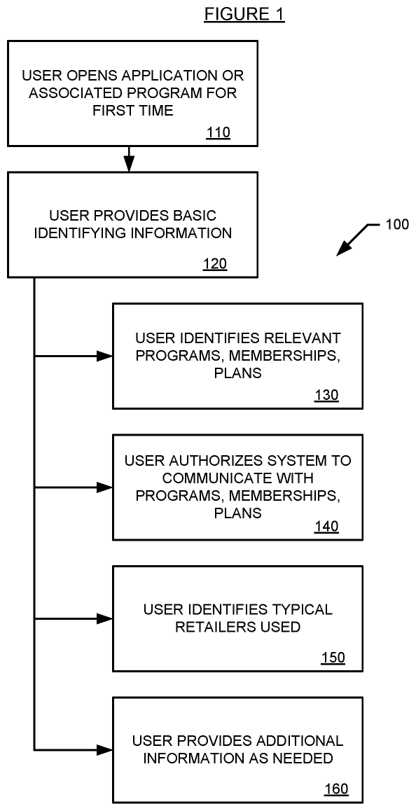

A user may establish his or her information necessary to identify at least one program. Alternatively, a user may establish a profile that may combine various programs. For example, and with reference to FIG. 1, a user may undergo an enrollment process 100. The first time a user opens the application or program at 110, the user may be requested to provide basic identification information at 120.

The user may then provide at 130 relevant programs, memberships, groups, etc. For example, a user may identify his or her insurance programs, alumni groups, civic organizations, entitlements, etc. Note that relevant programs may include member programs, which may be identified by the member number and/or card number of the user.

At 140 a user may authorize the systems of the present invention to communicate directly with the identified programs, memberships, groups, etc. identified above. This communication may take many forms. For example, systems of the present invention may webscrape sites offered by such groups to identify benefits. In some situations—for example, with regard to insurance programs—the system of the present invention may contact the insurance company directly and ask for a list of benefits (which may be periodically updated). Such request should not violate any privacy concerns, as specific treatment data is not provided or shared.

At 150 a user may have an option of identifying specific retailers. Such retailers may be those that the retailer has loyalty accounts, or is geographically proximate. In accordance with some embodiments of the present invention, if a user identifies a loyalty program in step 130, the system may automatically identify the retailer at this step 150. In accordance with some embodiments, the location of the user's device (or, for example, home address, work address, typical routes traveled (e.g., to-and-from work), etc. may provide a basis for either identifying local retailers, or making suggestions to the user.

At 160 a user may provide additional information as needed or desired by the application. For example, a user may be requested to provide certain account numbers (such as loyalty programs if not identified above), identifying information (such as an alumni account number, or bar association number), or even information pertaining to desired promotions (such as notifying the system of pets in the house, or young children).

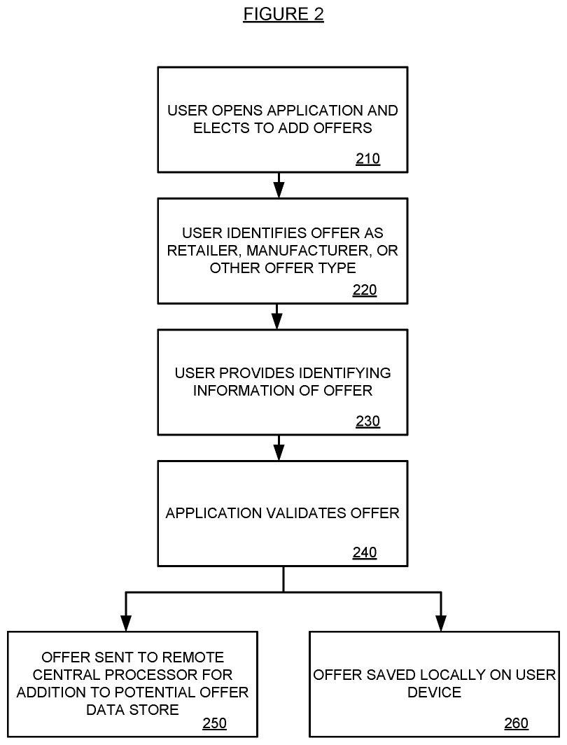

In accordance with some embodiments of the present invention, a user may also upload various promotions directly. For example, promotions may be from a manufacturer (e.g., manufacturer coupons), or from specific retailers or for specific programs. With reference to FIG. 2, an exemplary process 200 for uploading other promotions is illustrated. At 210 a user may open the application and elect to add offers. At 220 a user may identify offer as a retailer offer, manufacturer offer, or other offer type. In some embodiments of the present invention, the user may not associate the offer, and coupons may be applied by the system, rather than provided by the user and scanned at a point of sale.

At 230 the user may provide identifying information of the offer. For example, if the user is uploading a coupon, the bar code of the coupon may be captured by a camera functionality of the user device. Similarly, the entire coupon (front and/or back) may also be captured. Note that it is contemplated that a user may at times skip step 220 and provide the identifying information of the offer. The system may identify the offer as, for example, a manufacturer coupon from the information provided.

At 240 the application may validate the offer. For example, the offer may be validated in some circumstances by confirming that the expiration date has not passed, or by confirming that the bar code (or other indicia) captured by the user identifies a legitimate coupon. In accordance with some embodiments, an indicia of an item—such as a universal price code (UPC) may be entered or scanned to determine if there are any offers for the product or service, or if the product or service is eligible for certain membership programs. For other offers the application may confirm with the offer-provider the validity of the offer. The offer may then be saved for later use. For example, the offer may be saved at the remote central processor (at 250)—for example, in a relational database associated with the user, or may be saved on the local device storage—for example, on the user device itself.

In accordance with some embodiments of the present invention, the merchant where the customer is shopping may need to be identified. This may be accomplished in a number of ways, including but not limited to: manual selection by the user; “check in” via various social media applications; geolocation of the user device; determinations based upon wireless communications (such as wifi networks, etc.); etc. Some determinations may be made by the user device alone, by the user device in interaction with a central processor, and/or by the user device interacting with a point of sale (POS) terminal.

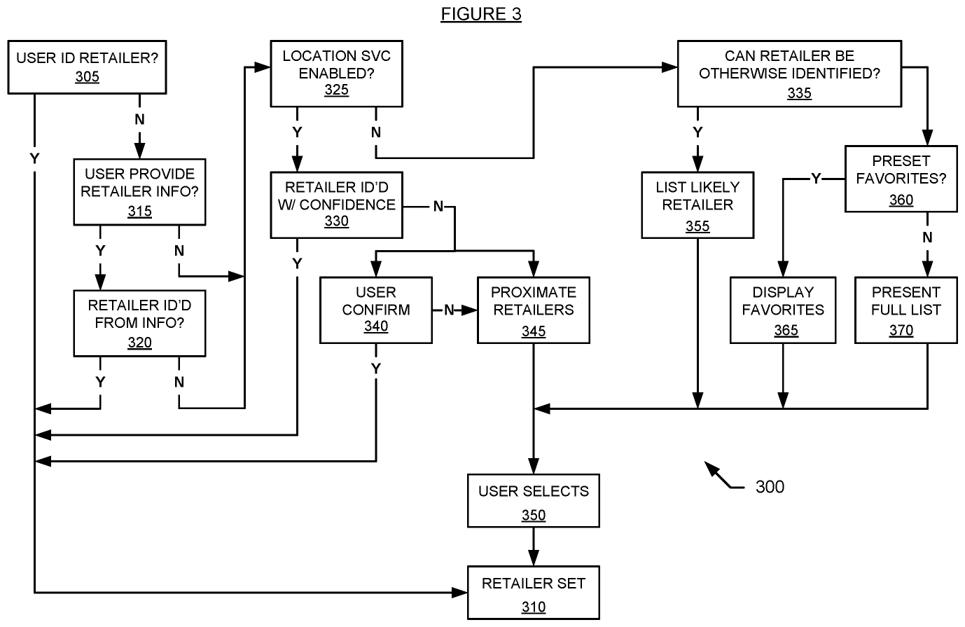

With reference to FIG. 3, an exemplary process 300 of identifying a retailer at which the user is present is illustrated. At 305 the system may first determine if the user has already identified the retailer, and if so, the process moves to 310 where the retailer is set. If the user did not specifically identify the retailer the process may move to 315, where it is determined if the user provided any information related to or associated with the retailer. If so, at 320 it is determined if the retailer can be identified with any confidence from the information. If so, the retailer is determined and set at 310.

If the retailer cannot be determined from the information—or if no information was provided at step 315, the process may continue to step 325. At 325 the system may determine if the user device has location services enabled. If so, at 330 it is determined if based on the location if the retailer can be identified with confidence. If so, then the identified retailer is set at 310. If the retailer cannot be identified with confidence from location services (for example, if the user is at shopping mall with multiple retailers in close proximity) the system may either request a user to confirm the retailer that may be proper at 340. If the user does not confirm the suggested retailer—or if no retailer can be identified with any confidence to suggest, then at 345 a list of geographically proximate retailers may be presented to the user. User selection may be received at 350, and then retailer subsequently set at 310.

If location services were not enabled at 325, then it is determined if the retailer can be otherwise identified with confidence at 335. For example, this may be through a “check in” on social media, statements made on various sites, wifi signals, etc. If so at 355 a list of likely retailers is presented to the user again at 350, and upon a selection the retailer is set at 310.

If no retailers can be identified with confidence at 335, then it may be determined if the user has any preset favorites at 360. If so, the list of favorites may be presented to the user at 364 for user selection at 350. However, if the user does not have any favorites identified, the user may be presented with a full list of participating merchants at 370 for user selection. Once selected at 350 the retailer may be set at 310. In accordance with some embodiments of the present invention, the user may be presented with a full list of retailers for manual selection.

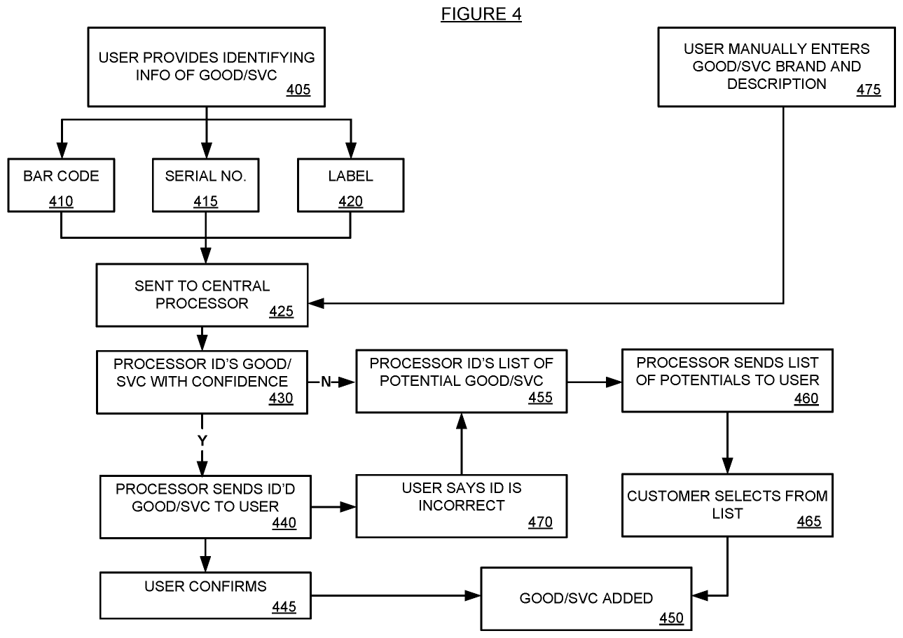

In accordance with some embodiments of the present invention, a user may select or identify a product and search retailers (such as but not limited to local or proximate retailers as established above), or may identify or select specific one or more specific retailers. With reference to FIG. 4, an exemplary process 400 is discussed.

At 405 a user may provide identifying information of a good or service. Such identifying information may be, for example, information captured by the user device—for example, through the device's camera functionality, or through RFID or other near-field communication. A bar code 410 may be captured by the device (for example, a stock keeping unit (SKU) or universal price code (UPC)). A serial number and/or model name or number may also be captured 420. In addition, it is contemplated that in some embodiments of the present invention, a user may also capture a label or tag of the product or service.

At 425 such information may be sent to the central processor for processing. The central processor may attempt to identify the good or service with a degree of confidence at 430. If the goods or services are identified with confidence, the identified goods or services may be sent to the customer's device at 440, and at 445 the customer may confirm the identification. One confirmed, the good or service may be added.

Adding a good or service may comprise adding the item to a purchase list, listing it as an item of interest (where, for example, a user may be notified of any promotions related to such item), or otherwise storing the good or service as associated with the user.

If the system cannot identify the good or service with confidence at 430, or if the customer indicates that the identified good or service at 440 is incorrect, the central processor may generate a list of potential goods or service that may be associated with the identifying information at 455, and such list may be provided to the user device at 460. At 465 the user may select the good or service from a list, and the good or service may be added at 450.

Note that a user may not be required to capture information relating to the good or service. Instead or in addition, a user may manually enter a product brand, model number, type, or description. The user may be presented with numerous options under each category to either select from, or which may present offers as the user types in the information. Once manually entered and selected, this information may again be sent to the central processor at 425, thereby undergoing subsequent processing similar to that above.

System.

As noted above, the system may in general comprise a user device equipped with an application, and in accordance with some embodiments of the present invention, in selective communication with a remote central processor.

The remote central processor (which may be referred to herein as a “central processor” or a “processor”) may be in selective communications with providers, issuers, administrators, etc. of user membership programs, loyalty programs, insurance plans, etc. identified by the user. Because the benefits of many programs vary (for example: customer loyalty benefits may vary weekly; insurance benefits may vary periodically; promotions may be for only a limited time, etc.), communication regarding the plans and programs may be required or desirable. In other words, the system of the present invention may not be set up with a single communication to load a database and then operate in isolation from the providers, issuers, administrators, etc. of the programs. In addition, the remote central processor may be in selective communication with other sponsors or providers of promotions—such as but not limited to manufacturers, specific retailers or specific retailer locations, etc.

In accordance with some embodiments of the present invention, the remote central processor may also be in selective communication with various retailers or providers. The central processor may determine and store (or access) various price tables or catalogs and other information regarding goods or services offered by the retailer or provider. In this manner, the central processor may maintain data stores of various items and eligibility from each different retailer or provider.

The remote central processor may also be able to maintain and update relevant data and make eligibility determinations. The application that resides on the user device may merely provide communication with the central processor and display results. Alternatively, the application that resides on the user device may locally make eligibility determinations based upon information saved or stored on the user device, or by the user device accessing a remote data store.

In accordance with some embodiments of the present invention the remote processor may push subsets of information to the application to be temporarily locally stored. For example, if a user is determined to be at a Kroger's grocery store, the remote central processor may push to the user device product information, coupons, promotions, and eligibilities (from one or more membership programs, loyalty programs, etc.) for products or services sold or available at Kroger's.

Once the user has completed the transaction, has left the retailer (or geographic area of the retailer), new data corresponding to a new or the same retailer is received, or a specific amount of time has elapsed, the local memory may be cleared of the information.

In accordance with some embodiments of the present invention, the user device may be loaded with all user, retailer, program/membership/loyalty, and product information. In such cases, the application may communicate with the remote central processor to periodically update the information.

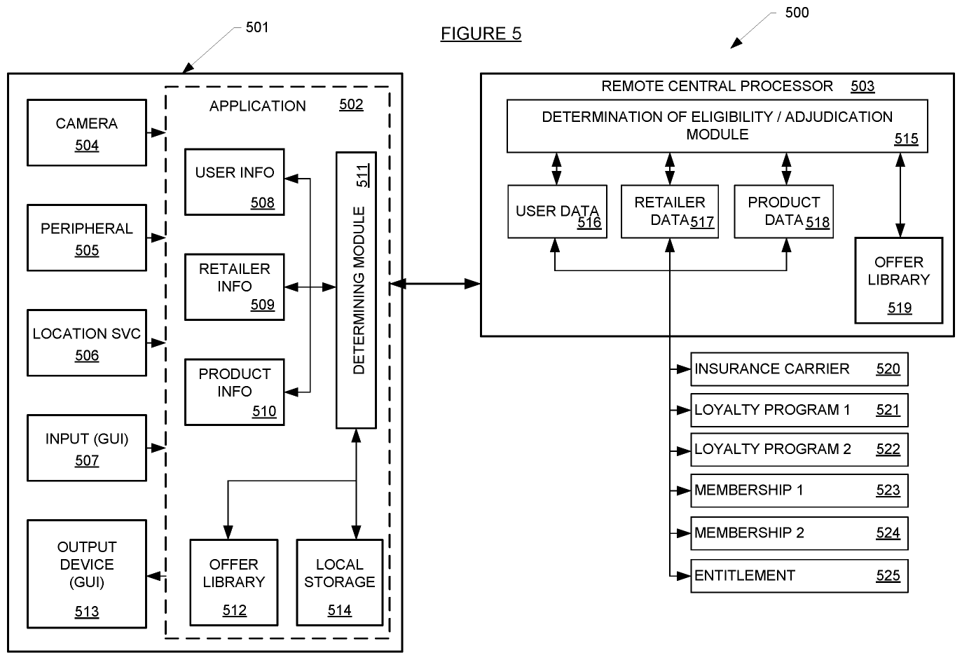

With reference to FIG. 5, an exemplary system schematic in accordance with some embodiments of the present invention will now be discussed. In general, system 500 may comprise a mobile device 501 with an application 502 residing thereon and a remote central processor 503.

In accordance with some embodiments, the user device 502 may comprise a camera module 504, one or more peripheral devices 505, location services 506, and/or a user input through a graphical user interface (GUI) 507. The application 502 may communicate with these elements. For example, the application 502 may communicate with the camera 504, peripheral device 505, location services 506, and the GUI 507 of the user device.

The application 502 may comprise, in general, a module that may store user information 508, a module that may store retailer information 509, and/or a module that may store product information. A determining module 511 may be selective communication with these modules 508, 509, 510, as well as with an offer library 512. Offer library 512 may store offers that are determined to be applicable to the user (or the current pending or anticipated transaction of the user). Such offers may be stored in a local storage 514, and may be provided to an output device 513, such as a GUI.

In other words, once an offer or promotion or benefit is determined to be applicable, it may be stored in the offer library until the user is ready to apply such offer, promotion, or benefit. At that point, the GUI of the mobile device may display what information may be necessary for the user to take advantage of the offer, promotion, or benefit. For example, the GUI may display a WIC identification number, a coupon bar code, etc.

Remote central processor 503 may comprise various modules, such as a determination module 515 that may determine eligibility and/or perform adjudication of offers vis-à-vis products or services identified by the user. In order to make such determinations, central processor 503 may also comprise various data stores, such as but not limited to user data store 516, retailer data store 517, product or service data store 518, and offer library 519. Note that offer library 519 in the remote central processor may comprise offers selected by the user, or may comprise offers for which the user may be eligible (whether or not selected or identified by the user). For example, offer library 519 may include an offer of buy-one-get-one-free for a certain product, but the user may not avail itself of such product or the corresponding offer.

Remote central processor 503 may also be in selective communication with the providers, issuers, administrators, and/or associated parties that may have, list, or provide such offers or promotions. For example, remote central processor 503 may be in selective communication with an insurance carrier 520, a first loyalty program (for example, at a grocery store) 521, a second loyalty program (for example, at a pharmacy) 522, a first membership program (for example, an alumni organization), a second membership program (for example, a club such as AAA), and/or an entitlement agency (such as WIC, MediCare, etc.) 525.

In this manner, the onus of monitoring and maintaining catalogs of offers relevant to a user may will be handled by the central processor 503 without bogging down the user device 501. Moreover, the remote central processor may have communication channels with numerous providers of promotions, etc. that may not require additional user input. For example, the remote central processor 503 may communicate with a couponing entity such as Catalina Marketing in order to be aware of, and provide to users, any applicable coupons without any additional user intervention.

Operation.

In operation, a user may initiate the application on his or her device. The user may have pre-registered with the application, thereby providing identifying information of various memberships, groups, loyalty programs, insurance plans, etc. as discussed above. The specific retailer for which the user is either present or curious about may be determined or provided by the user. The system may determine any promotions or offers specific to the retailer or specific retailer location. The user may be informed of the offers (without being limited by specific products), or such offers may be compared against specific products identified by the user.

For example, in accordance with some embodiments of the present invention, a user may activate the application and identify the retailer—for example a grocery store. As the user selects goods or services the user may scan the bar code or other identifying indicia of each product. The application may determine if there are any applicable offers or promotions for each of the goods or services. In some embodiments, the application may be enabled to inform the user of promotions or offers on different sizes, or equivalent products. For example, a user may scan Tide laundry detergent, and may be informed that there is an offer for All laundry detergent. The user may select the offer and scan the All product, or may decline the offer and continue with the selection of Tide detergent.

When the user approaches the POS to check out, the offers may be provided to the POS in a number of ways. For example, the device may communicate directly with the POS providing all relevant offers, identifying information, etc. Alternatively, the application may communicate with the POS (or the POS infrastructure) through the remote central processor. In accordance with some embodiments, the GUI of the user device may display one or more barcodes or other indicia that may be used at the POS to validate the offer.

For example, at purchase a user may finalize his or her promotions on the application. The application may present on the screen of the user device one or more bar codes representing customer loyalty programs, coupons, etc. It is contemplated that the application may provide multiple bar codes, or may provide a single bar code that is representative of all promotions utilized. If a single composite bar code is used, such information may be conveyed by the POS infrastructure back to the remote central processor for determination of all constituent offers for proper settlement. In this manner, the user need only identify each product and the systems and methods of the present invention may identify the most advantageous offer or promotion. In some circumstances, and where permitted, the application may “stack” offers, resulting in significant discounts.

Insurance Benefits.

As noted above, in accordance with some embodiments of the present invention, an application may be used to monitor, determine, and advise a user of various insurance benefits. For example, a user may utilize an application in accordance with some embodiments of the present invention to determine if a good or service is covered by aspects of his or her insurance program (such as determining if an over-the-counter (OTC) product is covered by insurance, an applicable HSA, MediCare Part B, etc.). In general, an application may allow members to scan or enter their account number and see their card available balance, Health Plan name and expiration date of their card. Such an application may also allow a member to scan or enter a UPC and select a retailer to determine if the item is eligible to purchase with their card and/or if there is a discount available on the item. In this manner, a health plan consumer—i.e., the user—may have the ability to view all eligible items and all available discounts at a given retailer. Moreover, such an application may additionally provide users with the ability to report an error when they believe either an item should be eligible or should be available at a discount.

In using an insurance aspect of the present invention, a user may log in to the application using various methods. For example, a user may open the application on his or her device, and may scan an applicable insurance card. The user may then be presented with a welcome screen that may identify his or her name (for example, displaying “Hello, John Doe!”), as well as card information. Card information may include card balance (if associated with an HSA or other health plan), the health plan or group name, and any expiration date.

In another embodiment, a user may manually type in the number present on his or her insurance card. The application may communicate with the central processor, which in turn may communicate with the insurance company to identify the user. As with above, the user may then be presented with a welcome screen and card information.

Once logged in the user may be presented with at least two options: “Scan UPC” or “Type UPC.” The user may then select one option, or it is contemplated that the option may be automatically selected for the user upon the insertion of text into the type field or the capture of an image. If “Scan UPC” is selected, the user may scan the UPC using the camera functionality of the device, or by using a peripheral device such as a bar code reader.

If the user selects “Type UPC,” the user may manually type in the UPC from the product packaging. In either case, the application in communication with the central processor may determine if the UPC is valid, and may display the good or service that is associated with the UPC.

A user may also select a retailer. Retailer may be selected and/or determined in a variety of manners as discussed above. In accordance with some embodiments of the present invention, the user may select the relevant retailer from a list of available or participating retailers. If a UPC has already been received, the application may determine if there any offers for the item at the identified retailer—or if the item is eligible for insurance benefits at the retailer.

Alternatively, the retailer may be identified before UPCs are received or entered, and the user may receive an indication of whether there are any offers/eligibility once the UPCs are entered. If the retailer is provided before a UPC is provided, it is also contemplated that the user may be presented with a list of eligible items from the retailer. This list may also be sent from the remote central processor to the application local memory for quicker processing and selection.

If an item is not eligible, a messaging conveying that may be provided to the user. For example, the device may display “No Offer Available.” If there are offers available, the device may display “Item Eligible,” and may list a quantity of available offers. Such available offers may include any associated expiration dates or other limiting information.

In accordance with some embodiments of the present invention, if an offer is not available for a specific item, or if the specific item is not eligible under the plan, similar items may be displayed that are eligible or for which there is an offer. This may be displayed automatically, or a user may select “Show Similar Eligible Items.” In this manner, even though a consumer provided a UPC for a specific ibuprofen product that is not eligible, other similar (and potentially functionally equivalent) products may be displayed.

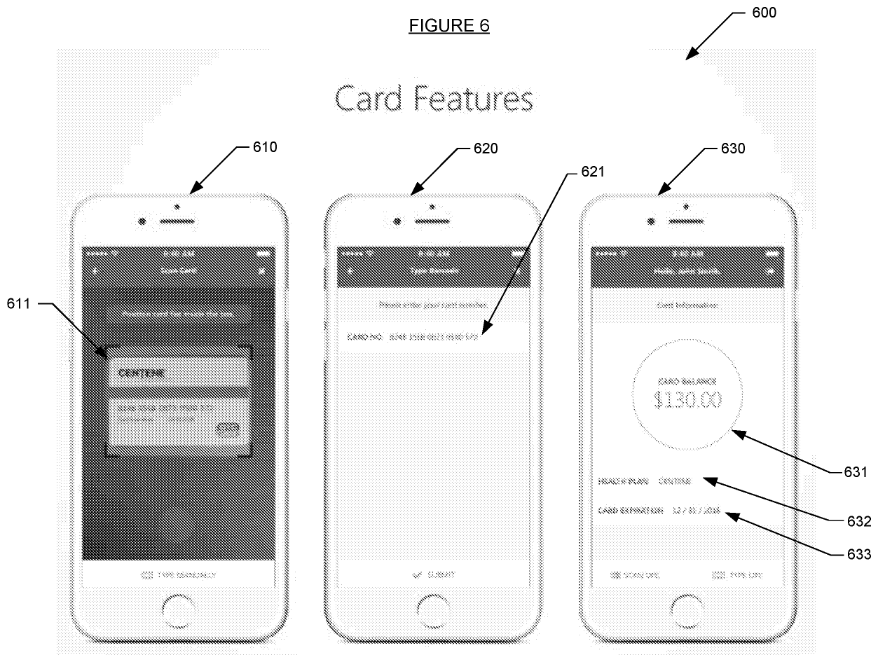

With reference to FIG. 6, exemplary screenshots 600 in accordance with some embodiments of the present invention will now be discussed. As discussed above, there may be a multitude of ways in which a user may identify a program, plan, etc. of which he or she may be a member. Screenshot 610 illustrates the capture of a user's plan information through a camera functionality of a user device. At 611, it can be seen that the camera functionality is capturing an image of the user's health insurance card. From this image, the relevant information (e.g., account number, plan number, group number, user name, etc.) may be obtained. At screenshot 620, the user may instead manually enter their health card identification number (seen at 621).

Once the system identifies the user's health card, if there is a balance available on such card (for example, through a HSA), the balance may be displayed at 631. Additional plan information, such as the plan name 632 and/or the expiration date of the card 633 may also be displayed.

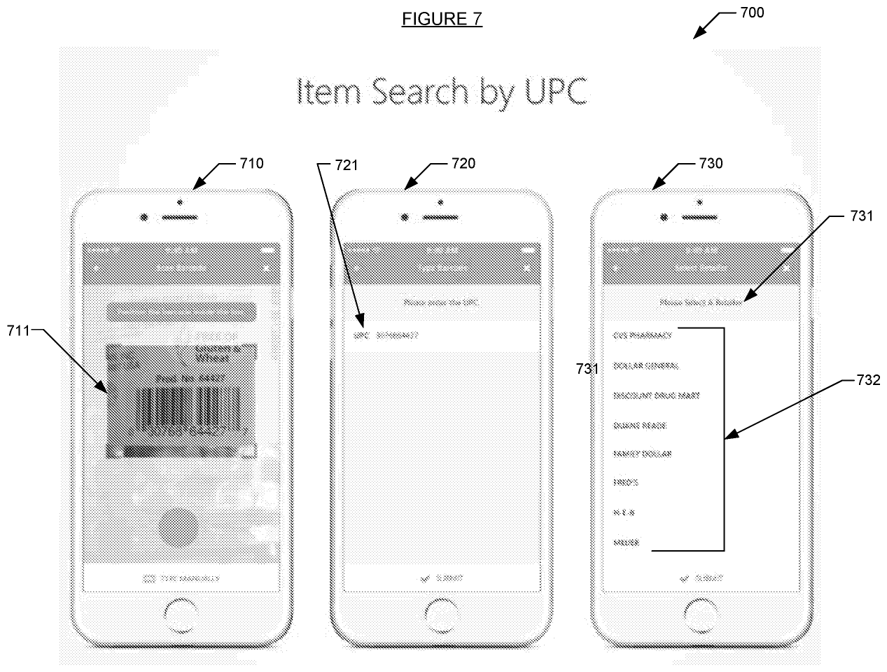

With reference to FIG. 7, exemplary screenshots 700 in accordance with some embodiments of the present invention will now be discussed. As discussed above, there may be a multitude of ways in which a user may identify a good or service. Screenshot 710 illustrates an embodiment in which an indicia (e.g., a UPC, SKU, etc.) of a good or service is captured 711 by a camera functionality of a user device. From this image, information thereon may be determined by the systems and methods and the good or service identified. Screenshot 720 illustrates an alternative embodiment in which the indicia (e.g., the UPC, SKU, etc.) is manually entered at 721.

The retailer may also be identified in any number of ways, including—as shown by screenshot 730—by manual selection of the user. The user may be requested to select a retailer at 731, and may select the retailer from a list 732, or may manually enter the retailer.

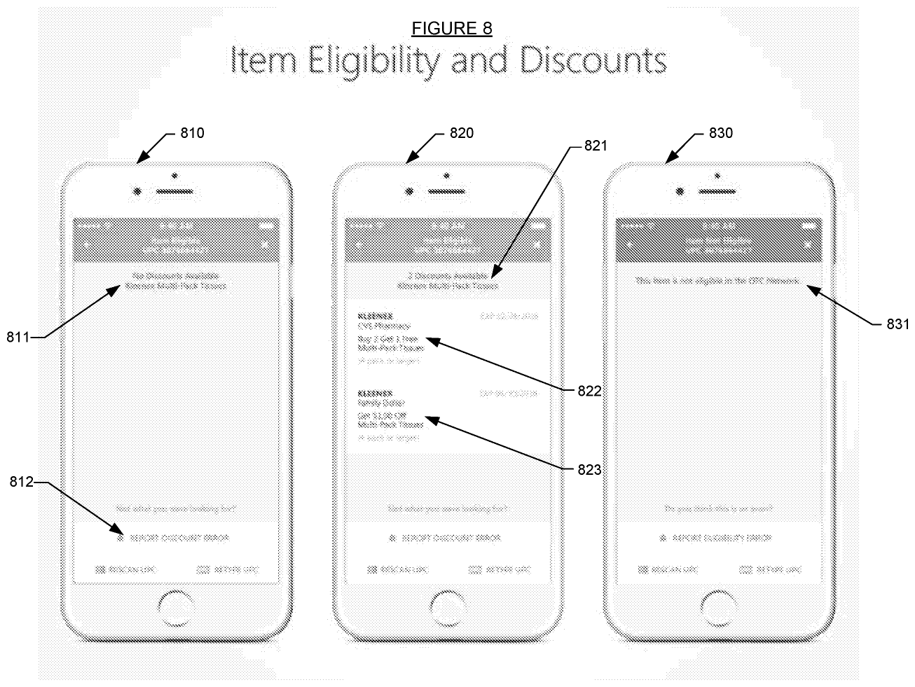

With reference to FIG. 8, screenshots 800 in accordance with some embodiments of the present invention will now be discussed. Screenshots 810, 820, and 830 generally correspond to item eligibility and discounts determinations. Screenshot 810 illustrates the results of a search for discounts of a specific product (here, Kleenex Multi Pack Tissues). At 811, a message is returned to the user that there are no current discounts available for this product. Note that at 812 (and throughout), a user may also report an error if the user believes that the response of the system is incorrect.

Screenshot 820 illustrates a situation where, as indicated at 821, two (2) discounts are available for Kleenex Multi Pack Tissues. At 822 a first discount is listed, where CVS Pharmacy may offer a buy two-get 1 free promotion. At 823 a second discount is listed, where Family Dollar may offer $1.00 off per item. A user may then determine which (if any) promotion is more advantageous and may partake.

Screenshot 830 illustrates exemplary results from a user who performed a search to see if the item (again, Kleenex Multi Pack) is eligible for over-the-counter (OTC) benefits. At 831 the system returns a message to the user that the item is not eligible. If the item was eligible, the system would have displayed its eligibility and any other relevant or necessary information.

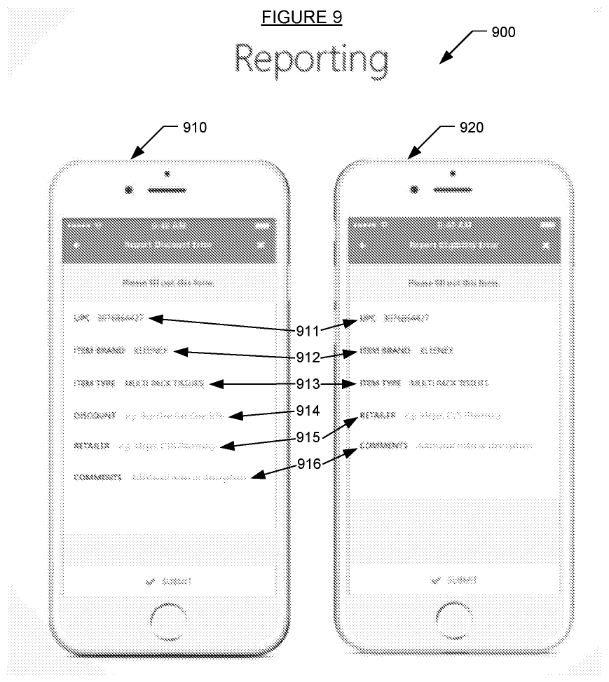

As noted above, in accordance with some embodiments of the present invention, a user may report what it believes to be errors in either discounts or eligibility determinations. FIG. 9 illustrates exemplary screenshots 900 of a user error reporting form. At 910 a user may report what he or she feels to be a discount determination error. At 920, a user may report what he or she feels to be an eligibility determination error. The information provided by the user in both situations is similar. At 911 a user may provide the product UPC (again, manually entered or captured by a camera functionality or other methodology (RFID, bar code reader, etc.). At 912 the user may provide (or the system may determine based on the UPC) the item brand. At 913 the item type may be provided by the user or determined and provided by the system. At 914 the discount that a user feels should be applied may be provided. Note that this field may not be present in the eligibility error report, since the eligibility determination does not typically provide specific unique discounts (instead, a product is generally eligible or not eligible).

At 915 the retailer may be provided or determined (for example, through the various methodologies discussed above). At 916 the user may provide any comments that may be useful in determining if there is in fact an error.

By utilizing user feedback, systems and methods in accordance with some embodiments of the present invention may stay more current and aware of various promotions, discounts, eligibility, etc. In some manners, providing users with the ability to submit what they believe to be promotions instills a sense of crowd-sourcing to the determination and application of every-changing promotions and eligibility.

It will be understood that the specific embodiments of the present invention shown and described herein are exemplary only. Numerous variations, changes, substitutions and equivalents will now occur to those skilled in the art without departing from the spirit and scope of the invention. Accordingly, it is intended that all subject matter described herein and shown in the accompanying drawings be regarded as illustrative only, and not in a limiting sense.

What is claimed is:

1. A system, comprising:
a processor;
one or more data stores, the one or more data stores storing data comprising:
user data, including memberships, groups, plans, and/or entitlements associated with a user;
retailer data, including:
products and services offered by a retailer;
any promotional offers offered by the retailer;
product and service data, including identification information of each product and service, and any promotional offers or plan eligibility associated with the product or service;
wherein the processor is in selective communication with one or more retailers, manufacturers, membership plans, insurance providers, and/or entitlement providers to populate and update the one or more data stores;
wherein the processor is in selective communication with a mobile device of the user;
wherein the processor further comprises a memory that stores executable instructions that, when executed by the processor facilitate the performance of operations comprising:
comparing first media data comprising identification information associated with a product or service received from the mobile device with product and service data stored in the one or more data stores;
based at least in part on the comparing, determining the product or service and identifying any promotional offers or plan eligibility associated with the product or service, the user, and/or the retailer;
ranking any promotional offers or plan eligibility associated with the product or service, the user, and/or the retailer based at least in part on size of promotion;
transmitting to the mobile device an identifier of one or more applicable promotional offers or plan eligibility, the identifier being presentable by the user to obtain the one or more promotional offers or plan eligibility.

2. The system of claim 1, wherein the first media data comprising identification information associated with a product or service comprises a bar code captured by a camera functionality of the mobile device.

3. The system of claim 2, wherein the product and service data comprises universal price code (UPC) and/or stock keeping unit (SKU) identifiers for each product and service, and wherein the bar code captured by the camera functionality is a UPC or SKU.

4. The system of claim 1, wherein the first media data comprising identification information associated with a product or service comprises a universal price code (UPC), stock keeping unit (SKU), or product identification number manually entered into the mobile device.

5. The system of claim 1, wherein the first media data comprising identification information associated with a product or service comprises an indication of a brand and product type or model of the product or service.

6. The system of claim 5, wherein the processor determines all applicable products and services that are associated with the first media data and provides the same to the mobile device for user selection.

7. The system of claim 1, wherein the performance of operations further comprises:
determining a geographic location of the mobile device based at least in part on location data indicative of a location of the mobile device; and
determining, based at least in part on the geographic location of the mobile device, one or more retailers proximate to the geographic location of the mobile device.

8. The system of claim 1, wherein identifying any promotional offers or plan eligibility associated with the product or service, the user, and/or the retailer comprises determining any promotional offers or plan eligibility associated with the one or more retailers proximate to the geographic location of the mobile device.

9. The system of claim 1, wherein the ranking of any promotional offers or plan eligibility associated with the product or service, the user, and/or the retailer comprises determining which if any promotional offers or eligibility are combinable.

10. A process conducted by a processor in selective communication with a mobile device of a user and one or more data stores, the one or more data stores storing data comprising user data, retailer data, and/or product and service data, the process conducted by executable instructions that, when executed by the processor cause:
comparing first media data comprising identification information associated with a product or service received from the mobile device with product and service data stored in the one or more data stores;
based at least in part on the comparing, determining the product or service and identifying any promotional offers or plan eligibility associated with the product or service, the user, and/or the retailer;
ranking any promotional offers or plan eligibility associated with the product or service, the user, and/or the retailer based at least in part on size of promotion;
transmitting to the mobile device an identifier of one or more applicable promotional offers or plan eligibility, the identifier being presentable by the user to obtain the one or more promotional offers or plan eligibility.

11. The process of claim 10, wherein the first media data comprises an image captured by a camera functionality of the mobile device.

12. The process of claim 11, wherein the processor determined if the image comprises a universal price code (UPC) or a stock keeping unit (SKU) identifier that identifies a product or service.

13. The system of claim 10, further comprising:
determining a geographic location of the mobile device based at least in part on location data indicative of a location of the mobile device; and
determining, based at least in part on the geographic location of the mobile device, one or more retailers proximate to the geographic location of the mobile device.

14. The system of claim 13, wherein identifying any promotional offers or plan eligibility associated with the product or service, the user, and/or the retailer comprises determining any promotional offers or plan eligibility associated with the one or more retailers proximate to the geographic location of the mobile device.

15. The system of claim 10, wherein the ranking of any promotional offers or plan eligibility associated with the product or service, the user, and/or the retailer comprises determining which if any promotional offers or eligibility are combinable.

16. A software application residing on a mobile device, the software application executing instructions causing:
soliciting data applicable to a user, retailer, and/or product or service through a user interface;
receiving input of data applicable to a user plan or membership, and/or product or service, wherein the input of data comprises an image captured by a camera functionality of the mobile device;
identifying the user plan or membership, and/or product or service based at least in part on the image;
determining any promotional offers or plan eligibility applicable to the user plan or membership, retailer, and/or product or service;
determining a location of the mobile device based at least in part on a location services functionality of the mobile device, and based at least in part on the location determining any proximate retailers;
determining any promotional offers or plan eligibility offered by the proximate retailers;
ranking any promotional offers or plan eligibility associated with the product and/or service, the user plan or membership, and/or the retailer based at least in part on size of promotion;
displaying to the user for selection an identifier of one or more applicable promotional offers or plan eligibility;
upon receiving user input selecting one or more applicable promotional offers or plan eligibility, displaying on a graphical user interface of the mobile device a computer readable indicia of the one or more applicable promotional offers or plan eligibility, if any.

17. The software application of claim 16, wherein the computer readable indicia comprises a bar code.

18. The software application of claim 16, wherein the ranking of any promotional offers or plan eligibility associated with the product or service, the user, and/or the retailer comprises determining which if any promotional offers or eligibility are combinable.

19. The software application of claim 16, wherein the identifying, ranking, and determining sets are performed based at least in part on communications with a remote central processor.
